(19) United States
(12) Patent Application Publication
(10) Pub. No.: US 2006/0103871 A1
(43) Pub. Date: May 18, 2006

(54) Methods, apparatus and computer program products supporting display generation in peripheral devices for communications terminals

(76) Inventor: Erwin Weinans, Klijndijk (NL)

Correspondence Address: MYERS BIGEL SIBLEY & SAJOVEC, P.A., P.O. BOX 37428, RALEIGH, NC, 27627, US

(21) Appl. No.: 10/990,060

(22) Filed: Nov. 16, 2004

(51) Int. Cl. G06F 3/12

(52) U.S. Cl. 358/1.15

(57) ABSTRACT

Text, e.g., call information, such as caller ID, is conveyed from a communications terminal, e.g. a mobile phone, to a peripheral device, e.g., a hands-free device. At the terminal, character data for the text is converted to image data. The terminal transmits the image data to the peripheral device using, for example, a wireless, wireline or optical link. The peripheral device generates an image on a display of the peripheral device from the transmitted image data. The image data may include a bit map and/or a graphics standard data set, e.g., a JPEG or GIF file. The conversion of character data to image data may be preceded by determining a characteristic of the display, and the character data may be converted to image data based on the determined characteristic.

### TECHNICAL FIELD OF THE INVENTION

The present invention generally relates to communications devices and, more particularly, to apparatus, methods, and computer program products supporting peripheral devices for communications terminals.

### DESCRIPTION OF RELATED ART

Communications terminals devices often have displays that are used to present information to a user of the device. For example, a mobile phone may include a display that indicates call status, caller identification (ID), and other information relating to calls.

Such displays may also be provided on peripheral devices that are used in conjunction with communications terminals. For example, “hands-free” devices for use with mobile phones may include a display that is used to display caller ID and/or other information. In such devices, caller ID may be transmitted from the mobile phone to the peripheral device as a stream of character indices that correspond to characters in the caller ID. Graphic characteristics of the characters of the character set may be stored in the peripheral device, and a display may be generated based on the transmitted indices and the stored graphic characteristics. An example of a hands-free device with such a display capability is the SonyEricsson HBH-200 headset.

Different character sets may be used for different languages around the world, e.g., Chinese, Thai, Roman, Cyrillic, and Arabic character sets. Some of these character sets may be very large. Accordingly, in order for a peripheral device to be useable for a wide variety of languages, it may need the capability to store large amounts of graphic data for the character sets. However, it may not be feasible or cost effective to provide such memory capacity in a peripheral device. In addition, it may not be feasible or cost-effective to provide a peripheral device with sufficient processing capability to perform the text processing that may be needed to render characters in manner consistent with the display at the communications terminal.

### SUMMARY

In some embodiments of the present invention, text (e.g., call information, such as caller ID) is conveyed from a communications terminal (e.g. a mobile phone) to a peripheral device (e.g., a hands-free device). At the terminal, character data for the text is converted to image data. The terminal transmits the image data to the peripheral device using, for example, a wireless, wireline or optical link. The peripheral device generates an image on a display of the peripheral device from the transmitted image data. The image data may include a bit map and/or a graphics standard data set, e.g., a JPEG or GIF file.

According to further embodiments of the present invention, conversion of character data to image data is preceded by determining a characteristic of the display. The conversion of the character data text to image data includes converting the character data to image data based on the determined characteristic. Determining a characteristic of the display may include receiving information pertaining to the characteristic at the communications terminal over a wireless communications link between the communications terminal and the peripheral device. The information pertaining to the characteristic may pertain to a location, dimension, capability and/or environment of the display.

In additional embodiments of the present invention, a wireless terminal includes a text-to-image converter configured to convert character data for text to image data and a communications circuit configured to transmit the image data from the wireless terminal to a peripheral device. The image data may include a bit map and/or a graphics standard data set. The text-to-image converter may be further operative to determine a characteristic of the display and to convert the character data to image data based on the determined characteristic. The communications circuit may receive information pertaining to the characteristic at the wireless terminal over a wireless communications link between the wireless terminal and the peripheral device and provide the information to the text-to-image converter.

In further embodiments, a peripheral device for a communications terminal includes a display, a communications circuit configured to receive image data from the communications terminal and a display controller operatively associated with the display and the communications circuit and a display controller configured to display an image on the display responsive to the received image data. The image data may include a bit map and/or a graphics standard data set. The communications circuit may transmit information pertaining to a characteristic of the display to the communications terminal. The information may pertain to a location, dimension, capability and/or environment of the display.

According to additional aspects of the present invention, computer program products for supporting a peripheral device of a communications terminal are provided. A computer program product includes computer program code embodied in a computer readable storage medium, the computer program code including code configured to convert text to image data and code configured to cause transmission of the image data from the communications terminal to the peripheral device. The computer program code may further include code configured to determine a characteristic of the display. The code configured to convert text to image data may include code configured to convert the text to image data based on the determined characteristic.

### BRIEF DESCRIPTION OF THE DRAWINGS

FIGS. 1 and 2 are schematic diagrams illustrating exemplary communications terminals and peripheral devices according to some embodiments of the present invention.

FIGS. 3 and 4 are flowcharts illustrating exemplary operations for conveying text between a communications terminal and a peripheral device according to further embodiments of the present invention.

### DETAILED DESCRIPTION OF EXEMPLARY EMBODIMENTS

The invention is described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that although the terms first and second may be used herein to describe various components these components should not be limited by these terms. These terms are only used to distinguish one component from another. Thus, for example, a first component discussed below could be termed a second component without departing from the teachings of the present invention.

The invention is described with reference to a flowchart and block diagrams of mobile terminals, communications networks, and operations thereof according to embodiments of the invention. It will be understood that each block of the flowchart and/or block diagrams, and combinations of blocks, may be implemented by computer program instructions. These computer program instructions may be provided to a processor or a general purpose computer, special purpose computer, or other programmable data processing apparatus to produce a machine, such that the instructions, which execute via the processor of the computer or other programmable data processing apparatus, create means for implementing the functions specified in the flowchart and/or schematic block or blocks.

It will be understood that the invention may be practiced with any of a number of different communications terminals that are configured to communicate with a communications network, e.g., a cellular telephony network, and with peripheral devices that provide augmented functionality, such as headsets and other “hands-free” devices. As referred to herein, a communications terminal includes, but is not limited to, cellular radiotelephones (with or without a multi-line display), wireline telephones (circuit-switched or packet network); Personal Communications System (PCS) terminals that may combine a telephone (wireless or otherwise) with data processing, facsimile and data communications capabilities; a Personal Data Assistant (PDA) that can include a mobile terminal, pager, Internet/intranet access, Web browser, organizer, calendar and/or a global positioning system (GPS) receiver; and a conventional laptop and/or palmtop receiver or other appliance all of which include a telephone transceiver.

In various embodiments of the present invention, text is converted into image data at a communications terminal (e.g., a mobile phone), and the image data (e.g., a bit map or a graphics standard data set, such as a JPEG or GIF file) is transmitted to a peripheral device (e.g., a headset or other hands-free device), which generates an image from the transmitted image data. Thus, for example, text processing may be performed at the terminal using the same text processing capability used to generate a display at the terminal, obviating the need for such processing at the peripheral device. This may, among other things, reduce complexity of the peripheral device, which may, in turn, reduce cost. According to further aspects of the present invention, the peripheral device may send information relating to a display characteristic of the device, such as a display field dimension, and the communications terminal may generate the image data from character data responsive to the display characteristic information. Because the peripheral device need not care about the textual content of the display, text and non-text graphical information may be conveyed together.

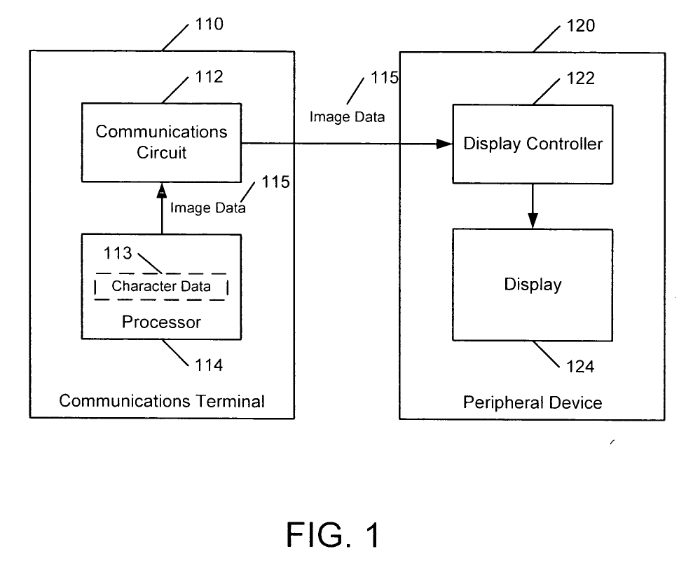

FIG. 1 illustrates apparatus and operations according to some embodiments of the present invention. A communications terminal 110 includes a communications circuit 112 that is configured to communicate with a peripheral device 120. The terminal 110 further includes a text-to-image (text/image) converter 114 that is configured to convert character data 113, e.g., ASCII or other non-image character representations, to image data 115. e.g., a bit map, JPEG file, GIF file or other representation of an image. The image data 115 is transmitted to the peripheral device 120 by the communications circuit 112. The peripheral device 120 includes a display 124 and a display controller 122 that generates an image on the display 124 responsive to the transmitted image data 115.

It will be appreciated that the communications terminal 110 may be any of a number of different communications devices, including, but not limited to, a mobile phone, a wireline phone, or a communications-enabled device, such as a wireless-enabled PDA, that may serve as a communications terminal. The text-to-image converter 114 may be implemented using any of a number of different electronic circuits, including programmed microprocessors, microcontrollers, or other data processing circuits and/or digital circuitry providing similar functionality. The peripheral device 120 may also take any of a number of different forms, including, but not limited to a headset or a vehicle hands-free device. The display 124 may be, for example, a color or monochrome liquid crystal display (LCD) or other display device. The display controller 122 may be implemented using any of a number of different electronic circuits, including programmed microprocessors, microcontrollers, or other data processing circuits and/or digital and/or analog circuitry providing similar functionality.

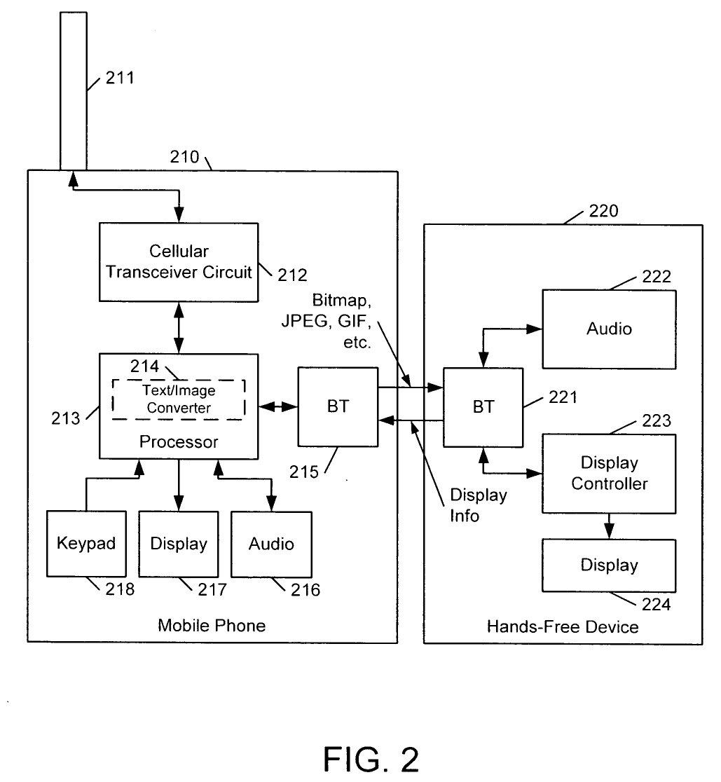

FIG. 2 illustrates an exemplary implementation for wireless applications according to some embodiments of the present invention. A mobile phone 210 includes a mobile communications circuit 212 that communicates with a wireless network via an antenna 211. The mobile phone 210 also includes a processor 213 that is operatively associated with the mobile communications circuit 212 and with a keypad 218, a display 217 and audio circuitry 216 (e.g., microphone, speaker and associated circuitry). The mobile phone 210 further includes a Bluetooth® (BT) interface circuit 215 that is also operatively associated with processor 213. The processor 213 is configured to provide a text-to-image converter 214, e.g., is configured to execute program code that provides character data to image data conversion along the lines described above. The processor 213 conveys image data, e.g., a bit map, JPEG file, GIF file, or the like, corresponding to textual information, such as caller ID, call status, or the like, to the Bluetooth® interface circuit 215, which transmits the image data to a hands-free device 220.

The hands-free device 220 (e.g., a headset or vehicle hands-free device) includes audio circuitry 222, a display generator 223 and a display 224. The hands-free device further includes a complementary Bluetooth® interface circuit 221 that receives the image data transmitted by the Bluetooth® interface circuit 215 of the mobile phone 210. The Bluetooth® interface circuit 221 provides the received image data to the display controller 223, which responsively generates an image on the display 224.

As further shown, the display controller 223 and the Bluetooth® interface circuit 221 of the hands-free device 220 may be further operative to provide display information to the mobile phone 210 via its Bluetooth® interface circuit 215. The display information may include, for example, information relating to locations and/or dimension of a display field of the display 224, information relating to display capabilities (e.g., monochrome vs. color) of the display 224, and/or information relating to a display environment (e.g., day vs. low-light conditions) of the display 224. The text/image converter 214 of the processor 213 may be configured to generate the image data transmitted to the hands-free device responsive to such display information. Thus, for example, the text/image converter may generate image data meeting certain location, size, color, intensity or other criteria tailored to the display 224 of the hands-free device 220.

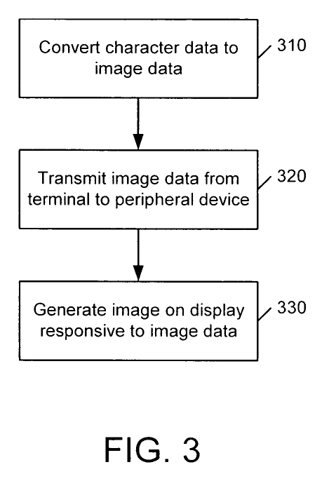

FIG. 3 illustrates exemplary operations for conveying text to a peripheral device that communicates with a communications terminal according to some embodiments of the present invention. The communications terminal converts character data for the text to image data (block 310). For example, the communications terminal may convert ASCII data or other non-image character data to a bitmap, JPEG, GIF or other image data format. The terminal transmits the generated image data to the peripheral device (block 320). The peripheral device responsively generates an image on its display from the transmitted image data (block 330).

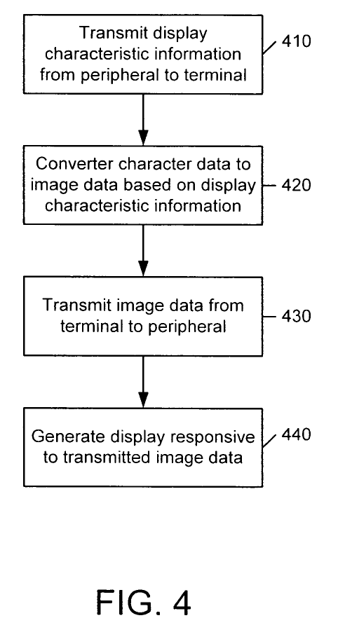

FIG. 4 illustrates further exemplary embodiments of the present invention in which image data may be generated based on display information relating to the display in a peripheral device for the communications terminal. Display characteristic information is transmitted from the peripheral device to the communications terminal (block 410). The display characteristic information may relate to, for example, size and/or location of a display field (or fields) of the display, capabilities of the display, such as support for color or monochrome images, and/or environmental characteristics of the display, such as the current ambient lighting in the display's environment. The terminal converts character data to image data based on the display characteristic information (block 420). For example, using dimensional information for a display field of the display of the peripheral device, the terminal may generate a bit map having the proper aspect ratio, resolution and/or other characteristics to provide a desired image on the display. Using capability information, the terminal may provide, for example, coloring or grey scale to meet the display's capabilities. The terminal transmits the generated image data to the peripheral device using, for example, a wireless, optical or wireline communications link (block 420). The peripheral device responsively generates an image on its display based on the transmitted image data (block 440).

It will be appreciated that the apparatus and operations of FIGS. 1-4 may be modified and/or augmented within the scope of the present invention. For example, in addition to converting character data to image data, a communications terminal could combine the resulting character image with non-character graphics, such as icons. In further embodiments, image data transmitted from a communications terminal to a peripheral device could be accompanied by control information, such as codes that indicate where and/or how an image is to be displayed. For example, image data sets transmitted from a terminal to a peripheral device could be “tagged” with predefined identifiers that indicate in which of a plurality of display fields of a peripheral device's each image data set is to be displayed. For example, respective image data sets for caller ID and call status fields could be identified by respective tags and/or respective image data sets may be generated for respective characters at a communications terminal and tagged such that a peripheral device receiving the image data sets can display the image data sets in appropriate character fields.

In further embodiments, a peripheral device could also be configured to provide both image-based transfer and conventional character data capabilities, e.g., a peripheral device could use conventional character data transfer and rendering techniques for certain languages (e.g., for English, Spanish, French, German, etc.), and could use image-data-based text transmission and display generation along lines described above for other languages, such as languages having relatively limited use and/or relatively large character sets (e.g., Mandarin Chinese). Using such techniques, a peripheral device could, for example, store a limited number character sets while being useable for language applications outside of those character sets.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A method of conveying text to a peripheral device that communicates with a communications terminal, the method comprising:
converting character data for the text to image data; and
transmitting the image data from the communications terminal to the peripheral device.

2. A method according to claim 1, further comprising generating an image on a display of the peripheral device from the transmitted image data.

3. A method according to claim 1, wherein the image data comprises a bit map and/or a graphics standard data set.

4. A method according to claim 1, wherein converting character data for the text to image data is preceded by determining a characteristic of a display of the peripheral device, and wherein converting the character data for the text to image data comprises converting the character data to image data based on the determined characteristic.

5. A method according to claim 4, wherein determining a characteristic of the display comprises receiving information pertaining to the characteristic at the communications terminal over a wireless communications link between the communications terminal and the peripheral device.

6. A method according to claim 5, wherein the information pertaining to the characteristic pertains to a location, dimension, capability and/or environment of the display.

7. A method according to claim 1, wherein transmitting the image data from the communications terminal to the peripheral device comprises transmitting the image data over a wireless link between the communications terminal and the peripheral device.

8. A method according to claim 1, wherein the text comprises call information.

9. A wireless terminal comprising:
a text-to-image converter configured to convert character data for text to image data; and
a communications circuit configured to transmit the image data from the wireless terminal to a peripheral device.

10. A wireless terminal according to claim 9, wherein the image data comprises a bit map and/or a graphics standard data set.

11. A wireless terminal according to claim 9, wherein the text-to-image converter is further operative to determine a characteristic of a display of the peripheral device and to convert the character data to image data based on the determined characteristic.

12. A wireless terminal according to claim 11, wherein the communications circuit is further operative to receive information pertaining to the characteristic at the wireless terminal over a wireless communications link between the wireless terminal and the peripheral device and to provide the information to the text-to-image converter.

13. A wireless terminal according to claim 12, wherein the information pertaining to the characteristic pertains to a location, dimension, capability and/or environment of the display.

14. A wireless terminal according to claim 9, wherein the communications circuit is configured to support a wireless link between the wireless terminal and the peripheral device.

15. A wireless terminal according to claim 9, wherein the text comprises call information.

16. A peripheral device for a communications terminal, the peripheral device comprising:
a display;
a communications circuit configured to receive image data from the communications terminal; and
a display controller operatively associated with the display and the communications circuit and configured to display an image on the display responsive to the received image data.

17. A device according to claim 16, wherein the image data comprises a bit map and/or a graphics standard data set.

18. A device according to claim 16, wherein the communications circuit is further operative to transmit information pertaining to a characteristic of the display to the communications terminal.

19. A device according to claim 18, wherein the characteristic pertains to a location, dimension, capability and/or environment of the display.

20. A device according to claim 16, wherein the communications circuit is configured to support a wireless communications link between the communications terminal and the peripheral device.

21. A computer program product for supporting a peripheral device of a communications terminal, the computer program product comprising computer program code embodied in a computer readable storage medium, the computer program code comprising:
code configured to convert text to image data; and
code configured to cause transmission of the image data from the communications terminal to the peripheral device.

22. A computer program product according to claim 21, wherein the image data comprises a bit map and/or a graphics standard data set.

23. A computer program product according to claim 21, wherein the computer program code further comprises code configure to determine a characteristic of a display of the peripheral device, and wherein the code configured to convert text to image data comprises code configured to convert the character data to image data based on the determined characteristic.

24. A method of conveying text to a peripheral device that communicates with a portable electronic device, the method comprising:
converting character data for the text to image data; and
transmitting the image data from the portable electronic device to the peripheral device.

25. A method according to claim 24, wherein converting character data for the text to image data is preceded by determining a characteristic of a display of the peripheral device, and wherein converting the character data for the text to image data comprises converting the character data to image data based on the determined characteristic.

26. A method according to claim 25, wherein determining a characteristic of a display of the peripheral device comprises receiving information pertaining to the characteristic at the portable electronic device over a wireless communications link between the portable electronic device and the peripheral device.

27. A portable electronic device comprising:
a text-to-image converter configured to convert character data for text to image data; and
a communications circuit configured to transmit the image data from the portable electronic device to a peripheral device.

28. A portable electronic device according to claim 27, wherein the image data comprises a bit map and/or a graphics standard data set.

29. A portable electronic device according to claim 27, wherein the text-to-image converter is further operative to determine a characteristic of a display of the peripheral device and to convert the character data to image data based on the determined characteristic.

30. A peripheral device for a portable electronic device, the peripheral device comprising:
a display;
a communications circuit configured to receive image data from the portable electronic device; and
a display controller operatively associated with the display and the communications circuit and configured to display an image on the display responsive to the received image data.

31. A device according to claim 30, wherein the communications circuit is further operative to transmit information pertaining to a characteristic of the display to the portable electronic device.

32. A computer program product for supporting a peripheral device of a portable electronic device, the computer program product comprising computer program code embodied in a computer readable storage medium, the computer program code comprising:
code configured to convert text to image data; and
code configured to cause transmission of the image data from the portable electronic device to the peripheral device.

33. A computer program product according to claim 32, wherein the computer program code further comprises code configured to determine a characteristic of a display of the peripheral device, and wherein the code configured to convert text to image data comprises code configured to convert the character data to image data based on the determined characteristic.

34. A computer program product according to claim 33, wherein the image data comprises a bit map and/or a graphics standard data set.
